(19) United States
(12) Patent Application Publication
(10) Pub. No.: US 2026/0348785 A1
(43) Pub. Date: Nov. 5, 2026

(54) Methods, Apparatus, Devices, and Media for Determining Dynamic Balance Quality Of Servo Motor

(71) Applicant: SIEMENS AKTIENGESELLSCHAFT, München (DE)

(72) Inventors: Song Ni, Nanjing, JS (CN); Li Yin, Nanjing, JS (CN); jun Cai, Nanjing, JS (CN); Cheng Yi Li, Nanjing, JS (CN); Hao Hu, Nanjing, JS (CN)

(73) Assignee: SIEMENS AKTIENGESELLSCHAFT, München (DE)

(21) Appl. No.: 19/485,810

(22) PCT Filed: May 26, 2023
(86) PCT No.: PCT/CN2023/096649

§ 371 Date: Nov. 19, 2025

(51) Int. Cl. G01M 1/16; H02P 21/18

(52) U.S. Cl. CPC G01M 1/16; H02P 21/18; H02P 2205/07

(57) ABSTRACT

Various embodiments of the teachings herein include a method for determining dynamic balance quality of servo motor. An example includes: obtaining a rotor speed signal of a servo motor at a set speed; determining an amplitude of a first-order component of the rotor speed signal; comparing the amplitude with a standard amplitude corresponding to the set speed, wherein the standard amplitude is determined based on a calibration process of a standard servo motor of the same type as the servo motor, and the standard servo motor comprises a standard rotor; and determining dynamic balance quality of the servo motor based on the comparison.

### CROSS-REFERENCE TO RELATED APPLICATIONS

This application is a U.S. National Stage Application of International Application No. PCT/CN2023/096649 filed May 26, 2023, which designates the United States of America, the contents of which are hereby incorporated by reference in their entirety.

### TECHNICAL FIELD

The present disclosure relates to servo control technology. Various embodiments of the teachings herein include methods, apparatus, devices, and media for determining dynamic balance quality of servo motor.

### BACKGROUND

Servo motor refers to an engine that controls the operation of mechanical components in a servo system. The rotor speed of servo motor is controlled by input signals and can react quickly. It is used as an executing element in automatic control systems and has characteristics such as small electromechanical time constant and high linearity. It can convert received electrical signal into angular displacement or angular velocity output on the motor shaft. Servo motors include DC servo motors and AC servo motors, and their main characteristics include: when the signal voltage is zero, there is no autorotation phenomenon, and the speed decreases uniformly with the increase of torque.

Dynamic balance quality is an important characteristic of servo motor performance, which affects vibration and noise of the motor body, and has a significant impact on machining accuracy. At present, it is necessary to use specialized rotor dynamic balance measuring equipment (such as a rotor dynamic balance machine) to detect the quality of dynamic balance of servo motor.

### SUMMARY

Teachings of the present disclosure include methods, apparatus, electronic devices, and media for determining dynamic balance quality of servo motor. For example, some embodiments include a method for determining dynamic balance quality of servo motor, comprising: obtaining (101) a rotor speed signal of a servo motor at a set speed; determining (102) an amplitude of a first-order component of the rotor speed signal; comparing (103) the amplitude with a standard amplitude corresponding to the set speed, wherein the standard amplitude is determined based on a calibration process of a standard servo motor of the same type as the servo motor, and the standard servo motor comprises a standard rotor; and determining (104) dynamic balance quality of the servo motor based on a comparison result.

In some embodiments, the rotor speed signal is acquired after the servo motor enters a steady state; and determining (102) an amplitude of a first-order component of the rotor speed signal comprises: converting the rotor speed signal into a frequency domain signal based on Fourier transform; determining a first-order component of the frequency domain signal; determine an amplitude of the first-order component.

In some embodiments, determining (102) an amplitude of a first-order component of the rotor speed signal comprises: performing order analysis on the rotor speed signal to determine a first-order component of the rotor speed signal; and determining an amplitude of the first-order component.

In some embodiments, determining (104) dynamic balance quality of the servo motor based on a comparison result comprises at least one of the following: determining that the dynamic balance quality is qualified when the amplitude is less than or equal to the standard amplitude, or determining that the dynamic balance quality is unqualified when the amplitude is greater than the standard amplitude.

In some embodiments, the number of set speeds is N, the number of amplitudes is N, and N is a positive integer of at least 2; and determining (104) dynamic balance quality of the servo motor based on a comparison result comprises at least one of the following: determining that the dynamic balance quality is qualified when N amplitudes are less than or equal to respective N standard amplitudes; or determining that the dynamic balance quality is unqualified when at least one amplitude is greater than respective at least one standard amplitude.

In some embodiments, the method comprises: determining the standard rotor based on a dynamic balancing equipment; installing the standard rotor in the standard servo motor of the same type as the servo motor; obtaining respective rotor speed signals of the standard servo motor at respective set speeds; s determining respective amplitudes of respective first order components of the respective rotor speed signals; and calibrating a relationship curve between set speed and standard amplitude based on the set speeds and respective amplitudes.

As another example, some embodiments include an apparatus for determining dynamic balance quality of servo motor, comprising: an obtaining module (601), configured to obtain a rotor speed signal of a servo motor at a set speed; a first determining module (602), configured to determine an amplitude of a first-order component of the rotor speed signal; a comparing module (603), configured to compare the amplitude with a standard amplitude corresponding to the set speed, wherein the standard amplitude is determined based on a calibration process of a standard servo motor of the same type as the servo motor, and the standard servo motor comprises a standard rotor; and a second determining module (604), configured to determine dynamic balance quality of the servo motor based on a comparison result.

In some embodiments, the rotor speed signal is acquired after the servo motor enters a steady state; and the first determining module (602), configured to convert the rotor speed signal into a frequency domain signal based on Fourier transform; determine a first-order component of the frequency domain signal; determine an amplitude of the first-order component.

In some embodiments, the first determining module (602) is configured to perform order analysis on the rotor speed signal to determine a first-order component of the rotor speed signal; and determine an amplitude of the first-order component.

In some embodiments, the second determining module (604), is configured to perform at least one of the following: determining that the dynamic balance quality is qualified when the amplitude is less than or equal to the standard amplitude, or determining that the dynamic balance quality is unqualified when the amplitude is greater than the standard amplitude.

In some embodiments, the number of set speeds is N, the number of amplitudes is N, and N is a positive integer of at least 2; and the second determining module (604), configured to perform at least one of the following: determining that the dynamic balance quality is qualified when N amplitudes are less than or equal to respective N standard amplitudes; and determining that the dynamic balance quality is unqualified when at least one amplitude is greater than respective at least one standard amplitude.

In some embodiments, the apparatus includes a calibrating module (605), configured to determine the standard rotor based on a dynamic balancing equipment; install the standard rotor in the standard servo motor of the same type as the servo motor; obtain respective rotor speed signals of the standard servo motor at respective set speeds; determine respective amplitudes of respective first order components of the respective rotor speed signals; and to calibrate a relationship curve between set speed and standard amplitude based on the set speeds and respective amplitudes.

As another example, some embodiments include an electronic device, comprising a processor (701) and a memory (702), wherein an application program executable by the processor (701) is stored in the memory (702) for causing the processor (701) to execute one or more of the methods for determining dynamic balance quality of servo motor as described herein.

As another example, some embodiments include a computer-readable medium comprising computer-readable instructions stored thereon, wherein the computer-readable instructions for executing one or more of methods for determining dynamic balance quality of servo motor as described herein.

As another example, some embodiments include a computer program product comprising a computer program, upon the computer program is executed by a processor for executing one or more of the methods for determining dynamic balance quality of servo motor as described herein.

### BRIEF DESCRIPTION OF THE DRAWINGS

In order to make technical examples of the present disclosure clearer, accompanying drawings to be used in description of the examples are introduced here. The accompanying drawings represent only some examples of the embodiments of the present disclosure. Those skilled in the art may obtain other drawings according to these accompanying drawings without creative labor.

FIG. 1 is a flowchart of an example method for determining dynamic balance quality of servo motor incorporating teachings of the present disclosure;

FIG. 2 is a schematic diagram of calibration relationship curve between set speed and standard amplitude incorporating teachings of the present disclosure;

FIG. 3 is a first schematic diagram of an example for determining dynamic balance quality of servo motor based on a single point incorporating teachings of the present disclosure;

FIG. 4 is a second schematic diagram of an example for determining dynamic balance quality of servo motor based on a single point incorporating teachings of the present disclosure;

FIG. 5 is a schematic diagram of an example for determining dynamic balance quality of servo motor based on multiple points incorporating teachings of the present disclosure;

FIG. 6 is a structural diagram of an example apparatus for determining dynamic balance quality of servo motor incorporating teachings of the present disclosure; and

FIG. 7 is a structural diagram of an example electronic device incorporating teachings of the present disclosure.

### LIST OF REFERENCE NUMBERS

| reference numbers | meanings |
|---|---|
| 101~104 | steps |
| 10 | calibrated relationship curve |
| A/B/C/D/E/F/G | points |
| 600 | apparatus for determining |
| | dynamic balance quality of servo |
| | motor |
| 601 | obtaining module |
| 602 | first determining module |
| 603 | comparing module |
| 604 | second determining module |
| 605 | calibrating module |
| 700 | electronic device |
| 701 | processor |
| 702 | memory |

### DETAILED DESCRIPTION

Some embodiments of the teachings herein include a method for determining dynamic balance quality of servo motor. An example method includes: obtaining a rotor speed signal of a servo motor at a set speed; determining an amplitude of a first-order component of the rotor speed signal; comparing the amplitude with a standard amplitude corresponding to the set speed, wherein the standard amplitude is determined based on a calibration process of a standard servo motor of the same type as the servo motor, and the standard servo motor comprises a standard rotor; and determining dynamic balance quality of the servo motor based on a comparison result. These methods utilize signal processing technology to obtain amplitude of rotor speed of motor when operating at a set speed, and compares it with standard amplitude of the set speed to determine dynamic balance quality, overcome or reduce the dependence on rotor dynamic balance measurement equipment, and thus reduce costs and testing time.

In some embodiments, the rotor speed signal is acquired after the servo motor enters a steady state; wherein determining an amplitude of a first-order component of the rotor speed signal comprises: converting the rotor speed signal into a frequency domain signal based on Fourier transform; determining a first-order component of the frequency domain signal;
determine an amplitude of the first-order component. Therefore, using Fourier transform to convert rotor speed signal acquired after the servo motor enters steady state into a frequency domain signal, and then determining the amplitude of the first order component of the frequency domain signal, thus quickly determine the amplitude.

In some embodiments, determining an amplitude of a first-order component of the rotor speed signal comprises: performing order analysis on the rotor speed signal to determine a first-order component of the rotor speed signal; and determining an amplitude of the first-order component. Therefore, there is no need to wait for the servo motor to enter a steady state. Through order analysis, the amplitude of the first order component can be quickly obtained, and spectral line blurring defects can be avoided.

In some embodiments, determining dynamic balance quality of the servo motor based on a comparison result comprises at least one of the following: determining that the dynamic balance quality is qualified when the amplitude is less than or equal to the standard amplitude, and determining that the dynamic balance quality is unqualified when the amplitude is greater than the standard amplitude. Therefore, by comparing individual amplitude, the dynamic balance quality can be quickly determined.

In some embodiments, the number of set speeds is N, the number of amplitudes is N, and N is a positive integer of at least 2; and determining dynamic balance quality of the servo motor based on a comparison result comprises at least one of the following: determining that the dynamic balance quality is qualified when N amplitudes are less than or equal to respective N standard amplitudes; determining that the dynamic balance quality is unqualified when at least one amplitude is greater than respective at least one standard amplitude. Therefore, by comparing multiple amplitudes, the accuracy of dynamic balance quality is improved.

In some embodiments, the method includes: determining the standard rotor based on a dynamic balancing equipment; installing the standard rotor in the standard servo motor of the same type as the servo motor; obtaining respective rotor speed signals of the standard servo motor at respective set speeds; determining respective amplitudes of respective first order components of the respective rotor speed signals; and calibrating a relationship curve between set speed and standard amplitude based on the set speeds and respective amplitudes. Therefore, the relationship curve between set speed and standard amplitude is pre calibrated, to facilitate subsequent provision of standard amplitudes.

Some embodiments include an apparatus for determining dynamic balance quality of servo motor comprising: an obtaining module, configured to obtain a rotor speed signal of a servo motor at a set speed; a first determining module, configured to determine an amplitude of a first-order component of the rotor speed signal; a comparing module, configured to compare the amplitude with a standard amplitude corresponding to the set speed, wherein the standard amplitude is determined based on a calibration process of a standard servo motor of the same type as the servo motor, and the standard servo motor comprises a standard rotor; and a second determining module, configured to determine dynamic balance quality of the servo motor based on a comparison result. These systems utilize signal processing technology to obtain amplitude of rotor speed of motor when operating at a set speed and compares it with standard amplitude of the set speed to determine dynamic balance quality, overcome or reduce the dependence on rotor dynamic balance measurement equipment, and thus reduce costs and testing time.

In some embodiments, the rotor speed signal is acquired after the servo motor enters a steady state; and the first determining module is configured to convert the rotor speed signal into a frequency domain signal based on Fourier transform; determine a first-order component of the frequency domain signal; determine an amplitude of the first-order component. Therefore, using Fourier transform to convert the rotor speed signal acquired after the servo motor enters steady state into a frequency domain signal, and then determining the amplitude of the first order component of the frequency domain signal, thus quickly determine the amplitude.

In some embodiments, the first determining module is configured to perform order analysis on the rotor speed signal to determine a first-order component of the rotor speed signal; determine an amplitude of the first-order component. Therefore, there is no need to wait for the servo motor to enter a steady state. Through order analysis, the amplitude of the first order component can be quickly obtained, and spectral line blurring defects can be avoided.

In some embodiments, the second determining module is configured to perform at least one of the following: determining that the dynamic balance quality is qualified when the amplitude is less than or equal to the standard amplitude, or determining that the dynamic balance quality is unqualified when the amplitude is greater than the standard amplitude. Therefore, by comparing individual amplitude, the dynamic balance quality can be quickly determined.

In some embodiments, the number of set speeds is N, the number of amplitudes is N, and N is a positive integer of at least 2; and the second determining module is configured to perform at least one of the following: determining that the dynamic balance quality is qualified when N amplitudes are less than or equal to respective N standard amplitudes; or determining that the dynamic balance quality is unqualified when at least one amplitude is greater than respective at least one standard amplitude. Therefore, by comparing multiple amplitudes, the accuracy of dynamic balance quality is improved.

In some embodiments, the system includes: a calibrating module, configured to determine the standard rotor based on a dynamic balancing equipment; install the standard rotor in the standard servo motor of the same type as the servo motor; obtain respective rotor speed signals of the standard servo motor at respective set speeds; determine respective amplitudes of respective first order components of the respective rotor speed signals; and to calibrate a relationship curve between set speed and standard amplitude based on the set speeds and respective amplitudes. Therefore, the relationship curve between set speed and standard amplitude is pre calibrated, to facilitate the subsequent provision of standard amplitudes.

Some embodiments include an electronic device comprising a processor and a memory, wherein an application program executable by the processor is stored in the memory for causing the processor to execute one or more of the methods for determining dynamic balance quality of servo motor as described herein.

Some embodiments include a computer-readable medium has computer-readable instructions stored thereon. The computer-readable instructions, when executed by a processor, implement one or more of the methods for building knowledge graph or a method for determining dynamic balance quality of servo motor as described herein.

Some embodiments include a computer program product comprising a computer program which, when executed by a processor, executes one or more of the methods for determining dynamic balance quality of servo motor as described herein.

### DETAILED DESCRIPTION

In order to make the purpose, technical scheme, and potential advantages of the teachings of the present disclosure more clear, the following examples are given to further explain in detail. In order to be concise and intuitive in description, the schemes are described below by describing several representative embodiments. Many details in the embodiments are only used to help understand the schemes. However, it is obvious that the technical schemes can be realized without being limited to these details. In order to avoid unnecessarily blurring the details, some embodiments are not described in detail, but only the framework is given. Hereinafter, “including” refers to “including but not limited to”, “according to . . . ” refers to “at least according to . . . , but not limited to . . . ” Due to the language habits of Chinese, when the number of an element is not specifically indicated below, it means that the element can be one or more or can be understood as at least one.

Considering the cost limitation of using specialized rotor dynamic balance measurement equipment to detect dynamic balance quality of servo motor, teachings of the present disclosure utilize signal processing technology to obtain amplitude of rotor speed when the motor operates at a set speed, and compare it with standard amplitude of the set speed to determine the dynamic balance quality, thereby overcoming or reducing the dependence on the rotor dynamic balance measurement equipment.

When a servo motor is running, dynamic balancing generates additional torque with fluctuating cycles. The additional torque can be mapped to speed signals of rotor of the servo motor. For a specific type of motor, a standard dynamic balance level can be defined to distinguish rotor speed through amplitude curve fitting. If there is sufficient sample data, a mapping area of rotor speed and standard amplitude that reflects the dynamic balance level can be established as the basis for determining dynamic balance of the same type of motor, without the need for testing in a rotor dynamic balance machine and can directly detect the changes in dynamic balance status during customer application. Specifically:

When a rotor imbalance fault occurs, as the rotor rotates, a periodic additional torque f(t) is introduced based on original load torque T_{L0} of the motor as the rotor rotates. The frequency of the additional torque f(t) is the same as the rotor rotation frequency f_{c}, and the amplitude A is related to unbalanced mass m and eccentricity distance e of the rotor. That is:

$$\{ \begin{matrix}{T}_{L} = {T}_{L 0} + f ( t ) \\ f ( t ) = Asin ( 2 π {f}_{c} t ) = mge sin ( 2 π {f}_{c} t )\end{matrix} ;$$

According to known dynamic formula of motor transmission system:

$${T}_{e} - {T}_{L} = J \frac{{dw}_{m}}{dt} ;$$

Among them: Tₑ represents electromagnetic torque; T_{L} represents load torque; J represents rotational inertia of the motor; wₘ represents motor speed; g represents acceleration of gravity; t represents time.

Therefore, when the motor reaches steady state, if the load torque T_{L} is a constant value, then the motor speed wₘ is a constant value. However, if the load torque T_{L} is not a constant value, but a periodic fluctuation component, so the final steady-state belongs to dynamic equilibrium, and there will be fluctuations in relevant components.

Thus,

$${w}_{m} = {w}_{m 0} + \frac{mge}{2 π {f}_{c} J} cos ( 2 π {f}_{c} t ) ;$$

Among them: wₘ₀ represents set speed of the motor.

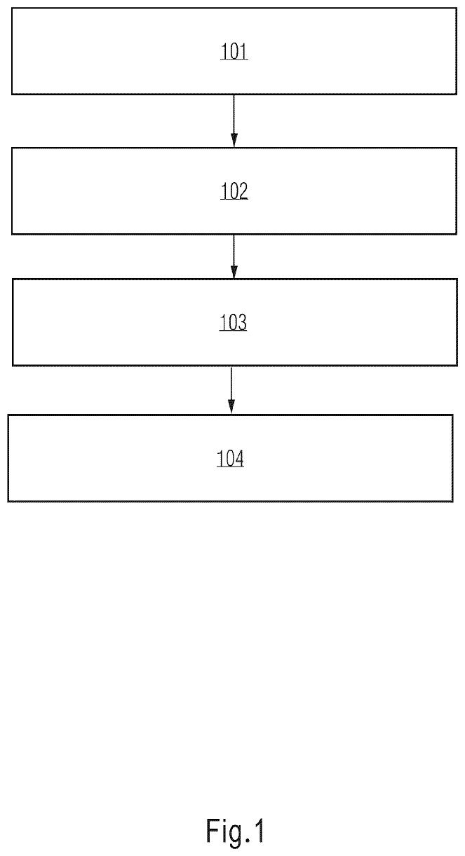

Based on the above derivation and analysis, embodiments of the present disclosure propose a method for determining dynamic balance quality of a servo motor. FIG. 1 is a flowchart of an example method for determining dynamic balance quality of servo motor incorporating teaching of the present disclosure. As shown in FIG. 1, the method comprises:

Step 101: obtaining a rotor speed signal of a servo motor at a set speed. For example, rotor speed signal at a set speed can be obtained from encoder of the servo motor.

Step 102: determining an amplitude of a first-order component of the rotor speed signal. In some embodiments, the rotor speed signal is acquired after the servo motor enters a steady state. Step 102 then comprises: converting the rotor speed signal into a frequency domain signal based on Fourier transform; determining a first-order component of the frequency domain signal; determine an amplitude of the first-order component. Here, Fourier transform is used to represent the rotor speed signal as a trigonometric function (sine and/or cosine function) or a linear combination of their integrals.

Fourier transform can be used to convert the rotor speed signal acquired after the servo motor enters a steady-state state into a frequency domain signal, and then determine the amplitude of the first-order component of the frequency domain signal, thus enabling rapid determination of the amplitude.

Step 103: comparing the amplitude with a standard amplitude corresponding to the set speed, wherein the standard amplitude is determined based on a calibration process of a standard servo motor of the same type as the servo motor, and the standard servo motor comprises a standard rotor. Under steady-state operating conditions, spectral analysis of vibration signals can effectively reveal the frequency components of the analyzed signal throughout the entire process but cannot reflect the law of frequency variation over time. For variable speed working conditions of servo motors, especially at the low-speed end, it is necessary to collect signals for a long time. If frequency domain analysis is still used for the vibration signals collected for a long time, it will cause peak energy dispersion on the spectrum and the phenomenon of spectral line blurring. Order analysis is an effective method for analyzing signals of variable speed operating conditions. Under variable speed conditions, order analysis can effectively compensate for the lack of spectrum under steady-state conditions. Order analysis is a resampling of the original time-domain signal, transforming equal time interval sampling into equal angle interval sampling. Therefore, the key to order analysis is to achieve equal angle sampling of the vibration signal, that is, to adjust the sampling rate accordingly based on the speed change of the reference shaft.

In some embodiments, Step 102 comprises: performing order analysis on the rotor speed signal to determine a first-order component of the rotor speed signal; determining an amplitude of the first-order component. The amplitude of the first order component can be quickly obtained through order analysis without waiting for the servo motor to enter steady state.

Step 104: determining dynamic balance quality of the servo motor based on a comparison result. For example, calibration can be performed on a standard servo motor of the same type as the servo motor in step 101, which includes a standard rotor. Based on the calibration results, determine relationship curve between each set speed and its corresponding amplitude (i.e., standard amplitude). Then, by querying the relationship curve using set speed as search term, the standard amplitude corresponding to the queried set speed can be obtained.

In some embodiments, the calibration process includes: determining the standard rotor based on a dynamic balancing equipment; installing the standard rotor in the standard servo motor of the same type as the servo motor; obtaining respective rotor speed signals of the standard servo motor at respective set speeds; determining respective amplitudes of respective first order components of the respective rotor speed signals; calibrating a relationship curve between set speed and standard amplitude based on the set speeds and respective amplitudes. For example, using dynamic balance equipment to determine whether a rotor meets the standard of dynamic balance grade G2.5. When met, determine that the rotor is a G2.5 standard rotor. Install the standard rotor in a servo motor of the same type as the motor in step 101 to form a standard servo motor that meets the dynamic balance level G2.5. Next, obtain rotor speed signals of the standard servo motor at multiple set speeds (such as obtaining the rotor speed signals from an encoder of the servo motor); determine respective amplitudes (i.e., standard amplitudes) of respective first order components of respective rotor speed signals. Based on multiple set speeds and respective amplitudes, calibrate relationship curve between set speeds and amplitudes. For example, the respective rotor speed signals during the calibration process can be converted into respective frequency domain signals based on Fourier transform. Then, determine respective first-order components of respective frequency signals; domain determine respective amplitudes (i.e., standard amplitudes) of respective first-order components. In some embodiments, perform order analysis on the respective rotor speed signals during the calibration process to determine respective first-order components of the respective rotor speed signals. Then determine respective amplitudes (i.e., standard amplitudes) of respective first-order component.

Step 104: determining dynamic balance quality of the servo motor based on a comparison result. In some embodiments, step 104 includes:
(1): determining that the dynamic balance quality is qualified when the amplitude is less than or equal to the standard amplitude. For example, suppose the speed is set to 2400 RPM. When amplitude of the first order component of the rotor speed of the tested servo motor containing the tested rotor at 2400 RPM is less than standard amplitude of standard servo motor (of the same type as the tested servo motor) that meets G2.5 at 2400 RPM, it is deemed that the tested rotor meets G2.5 standards.
(2): determining that the dynamic balance quality is unqualified when the amplitude is greater than the standard amplitude. For example, suppose the speed is set to 3600 RPM. When amplitude of the first order component of rotor speed of the servo motor to be tested containing rotor to be tested at 3600 RPM is greater than standard amplitude of a standard servo motor (of the same type as the tested servo motor) that meets G4.0 standards at 3600 RPM, it is determined that the tested rotor does not meet G4.0 standards.

In some embodiments, wherein the number of set speeds is N, the number of amplitudes is N, and N is a positive integer of at least 2, and step 104 includes: (1): determining that the dynamic balance quality is qualified when N amplitudes are less than or equal to respective N standard amplitudes. For example, assuming the set speed includes 1800 RPM, 2400 RPM, and 3000 RPM, that is, N equals 3. When the following three conditions are met simultaneously, the rotor to be tested is deemed to comply with G2.5 standard.
Condition (1): The amplitude of the first-order component of rotor speed of the servo motor to be tested containing rotor to be tested at 1800 RPM is less than standard amplitude of the standard servo motor (of the same type as the tested servo motor) that meets G2.5 at 1800 RPM;
Condition (2): The amplitude of the first-order component of rotor speed of the servo motor to be tested containing rotor to be tested at 2400 RPM is less than standard amplitude of the standard servo motor (of the same type as the tested servo motor) that meets G2.5 at 2400 RPM;
Condition (3): The amplitude of the first-order component of rotor speed of the servo motor to be tested containing rotor to be tested at 3000 RPM is less than standard amplitude of the standard servo motor (of the same type as the tested servo motor) that meets G2.5 at 3000 RPM.
(2): determining that the dynamic balance quality is unqualified when at least one amplitude is greater than respective at least one standard amplitude. For example, when at least one of the above three conditions is not met, it is determined that the rotor to be tested does not meet the G2.5 standard.

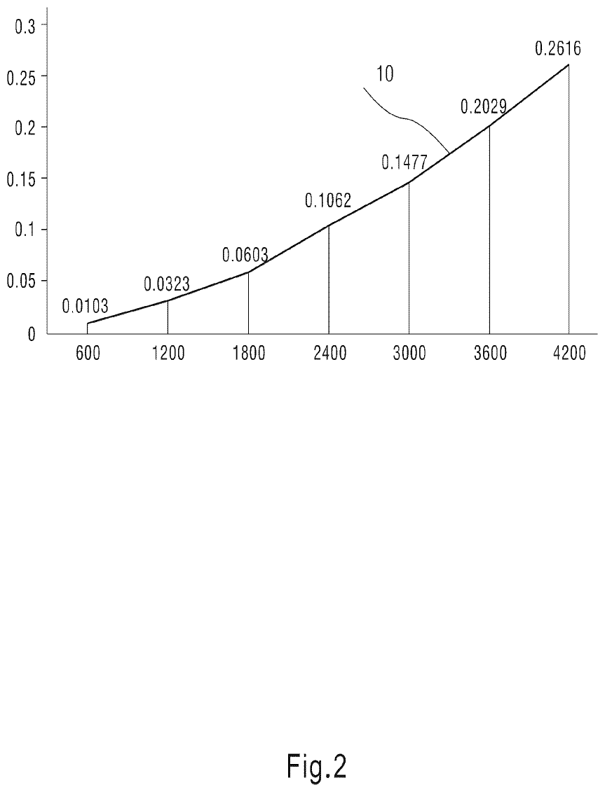

FIG. 2 is a schematic diagram of calibration relationship curve between set speed and standard amplitude incorporating teachings of the present disclosure. In FIG. 2, the horizontal axis represents set speed (for example, in RPM), and the vertical axis represents standard amplitude of the first order component of rotor speed signal of the same type model of servo motor (e.g. standard servo motor) containing standard rotor at the set speed. Among them, the rotor speed signals at respective set speeds can be obtained from encoder of the standard servo motor. Then, perform Fourier transform or order analysis on respective rotor speed signals to obtain respective amplitudes of respective first-order components of respective rotor speed signals.

For example, a standard rotor can be a standard rotor at various dynamic balance levels. The dynamic balance level represents the dynamic balance accuracy requirements of the rotor, and the common ratio between accuracy levels is usually 2.5. The dynamic balance level can include the following levels: G4000, G1600, G630, G250, G100, G40, G16, G6.3, G4.0, G2.5, G1, and G0.4. Among them, the smaller the number of balance accuracy levels, the higher the balance accuracy, and the smaller the residual imbalance. For each dynamic balance level, corresponding relationship curves can be calibrated separately.

The relationship curve 10 in FIG. 2 is calibration curve of a standard servo motor with G2.5, which includes corresponding relationship between multiple standard amplitudes and multiple set speeds. For example, when the motor speed is set to 1800 RPM, the corresponding standard amplitude is 0.0603; When the motor speed is set to 2400 RPM, the corresponding standard amplitude is 0.1062. The more rotational speeds are set, the higher the accuracy of the relationship curve between the set speed and the standard amplitude. When the number of speed settings is small, the relationship curve can be calculated using various types of interpolation algorithms. Based on relationship curve 10, it is possible to verify the rotor dynamic balance quality of motors of the same type.

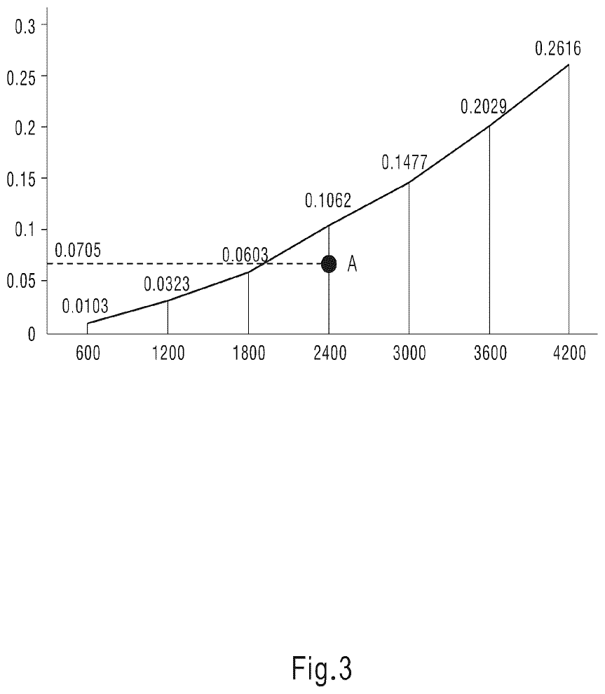

FIG. 3 is an example schematic diagram of determining dynamic balance quality of servo motor based on a single point incorporating teachings of the present disclosure. In FIG. 3, obtain speed signal of rotor to be tested at a set speed (such as 2400 RPM) from encoder of the servo motor to be tested containing the rotor. Based on Fourier transform or order analysis, the amplitude of the first-order component of speed signal of the rotor to be tested is determined to be 0.07, which corresponds to Point A in FIG. 3. From the relationship curve 10 in FIG. 2, when the speed is set to 2400 RPM, the standard amplitude of the motor containing G2.5 rotor is 0.1062. Since the amplitude (0.07) of the first-order component of the rotor speed signal of the servo motor to be tested is less than the standard amplitude (0.1062), it is determined that the dynamic balance quality of the rotor to be tested meets the requirements of G2.5.

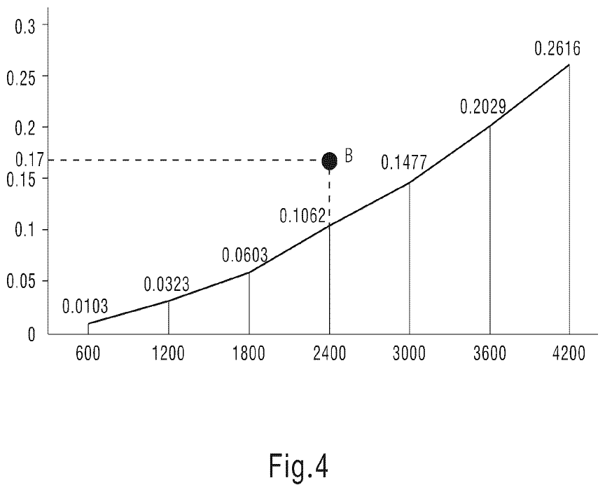

FIG. 4 is a second schematic diagram of determining dynamic balance quality of servo motor based on a single point incorporating teachings of the present disclosure. In FIG. 4, obtain the speed signal of the rotor to be tested at a set speed (such as 2400 RPM) from encoder of the servo motor to be tested containing the rotor. Based on Fourier transform or order analysis, the amplitude of the first-order component of the speed signal is determined to be 0.17, which corresponds to point B in FIG. 4. From the relationship curve 10 in FIG. 2, the standard amplitude of the motor containing G2.5 rotor is 0.1062 when set speed is 2400 RPM. Since the amplitude (0.17) of the first-order component of the speed signal of the rotor to be tested is greater than the standard amplitude (0.1062), it is determined that the dynamic balance quality of the rotor to be tested does not meet the requirements of G2.5.

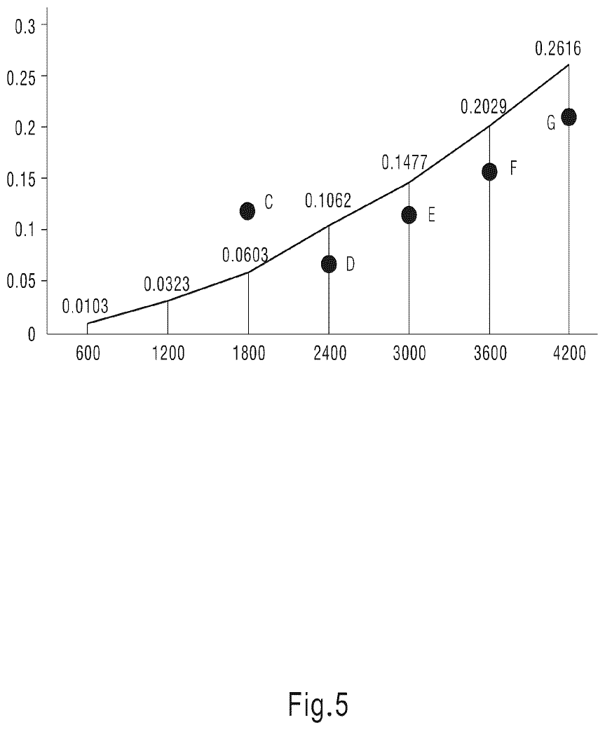

FIG. 5 is a schematic diagram of determining dynamic balance quality of servo motor based on multiple points incorporating teachings of the present disclosure. In FIG. 5, obtain the respective rotor speed signals at 5 set speeds (1800 RPM, 2400 RPM, 3000 RPM, 3600 RPM, and 4200 RPM) from encoder of the servo motor containing the rotor to be tested. Based on Fourier transform or order analysis, determine the amplitudes of the first order components of these 5 rotor speed signals, that is, determine points C to G in FIG. 5. Among them, points D to G are all located below relationship curve 10, while point C is above relationship curve 10. Therefore, it is determined that the dynamic balance quality of the rotor to be tested does not meet the requirements of G2.5.

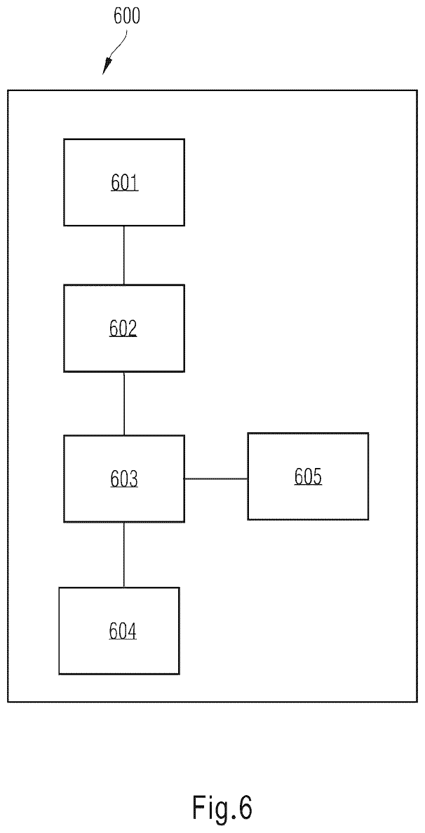

Based on the above description, some embodiments include apparatus for determining dynamic balance quality a servo motor. FIG. 6 is a structural diagram of an example apparatus for determining dynamic balance quality of servo motor incorporating teachings of the present disclosure. As shown in FIG. 6, an example apparatus 600 for determining dynamic balance quality of servo motor comprises: an obtaining module 601, configured to obtain a rotor speed signal of a servo motor at a set speed; a first determining module 602, configured to determine an amplitude of a first-order component of the rotor speed signal; a comparing module 603, configured to compare the amplitude with a standard amplitude corresponding to the set speed, wherein the standard amplitude is determined based on a calibration process of a standard servo motor of the same type as the servo motor, and the standard servo motor comprises a standard rotor; and a second determining module 604, configured to determine dynamic balance quality of the servo motor based on a comparison result.

In some embodiments, the rotor speed signal is acquired after the servo motor enters a steady state; and the first determining module 602 is configured to convert the rotor speed signal into a frequency domain signal based on Fourier transform; determine a first-order component of the frequency domain signal; and determine an amplitude of the first-order component.

In some embodiments, the first determining module 602 is configured to perform order analysis on the rotor speed signal to determine a first-order component of the rotor speed signal; and determine an amplitude of the first-order component.

In some embodiments, the second determining module 604 is configured to perform at least one of the following: determining that the dynamic balance quality is qualified when the amplitude is less than or equal to the standard amplitude; and determining that the dynamic balance quality is unqualified when the amplitude is greater than the standard amplitude.

In some embodiments, the number of set speeds is N, the number of amplitudes is N, and N is a positive integer of at least 2; and the second determining module 604 is configured to perform at least one of the following: determining that the dynamic balance quality is qualified when N amplitudes are less than or equal to respective N standard amplitudes; determining that the dynamic balance quality is unqualified when at least one amplitude is greater than respective at least one standard amplitude.

In some embodiments, the system comprises a calibrating module 605, configured to determine the standard rotor based on a dynamic balancing equipment; install the standard rotor in the standard servo motor of the same type as the servo motor; obtain respective rotor speed signals of the standard servo motor at respective set speeds; determine respective amplitudes of respective first order components of the respective rotor speed signals; and to calibrate a relationship curve between set speed and standard amplitude based on the set speeds and respective amplitudes.

In summary, teachings of the present disclosure may be used to determine the dynamic balance quality without the need for dynamic balance measurement equipment, and is particularly suitable for small axis high-speed servo motors, which can significantly save costs and time. Moreover, for customer applications: if there is a first-order velocity value in the initial state, when there is a load, the dynamic balance status of the entire system can be monitored; when there is no load, the dynamic balance state of the motor can be determined.

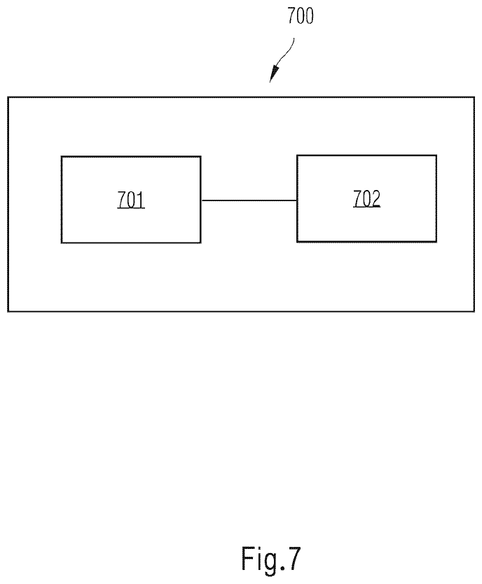

Some embodiments include an electronic device with processor-memory architecture. FIG. 7 is a structural diagram of an example electronic device incorporating teachings of the present disclosure. As shown in FIG. 7, the electronic device 700 comprises a processor 701, a memory 702, and a computer program stored in the memory 702 and executable on the processor 701. When the computer program is executed by the processor 701, any one of the above-mentioned methods for determining dynamic balance quality of servo motor. The memory 702 may specifically be implemented as various storage medium such as Electrically Erasable Programmable Read-Only Memory (EEPROM), Flash memory (Flash memory), Programmable Program Read-Only Memory (PROM). The processor 601 may be implemented to include one or more central processing units or one or more field programmable gate arrays, wherein the field programmable gate arrays integrate one or more central processing unit cores. In some embodiments, the central processing unit or central processing unit core may be implemented as a CPU or MCU or DSP, and so on.

It should be noted that not all steps and modules in the above-mentioned processes and structural diagrams are necessary, and some steps or modules may be omitted according to actual needs. The execution logic of each step is not fixed and can be adjusted as needed. The division of each module is only to facilitate the description of the functional division used. In actual implementation, a module can be implemented by multiple modules, and the functions of multiple modules can also be implemented by the same module. These modules can be in the same device or in a different device.

The hardware modules in various embodiments may be implemented mechanically or electronically. For example, a hardware module may include specially designed permanent circuits or logic devices (e.g., special-purpose processors, such as FPGAS or ASICs) to perform specific operations. Hardware modules may also include programmable logic devices or circuits temporarily configured by software (e.g., including general-purpose processors or other programmable processors) for performing operations. As for the specific mechanical method, or a dedicated permanent circuit, or a temporarily configured circuit (e.g., configured by software) to realize the hardware module, it can be decided according to cost and time considerations.

The above descriptions are merely example embodiments of the teachings of the present disclosure and are not intended to limit the protection scope thereof. Any modification, equivalent replacement, improvement, etc. made within the spirit and principle of the present disclosure shall be included within the protection scope thereof.

What is claimed is:

1. A method for determining dynamic balance quality of servo motor, the method comprising:
obtaining a rotor speed signal of a servo motor at a set speed;
determining an amplitude of a first-order component of the rotor speed signal;
comparing the amplitude with a standard amplitude corresponding to the set speed, wherein the standard amplitude is determined based on a calibration process of a standard servo motor of the same type as the servo motor, and the standard servo motor comprises a standard rotor; and
determining dynamic balance quality of the servo motor based on the comparison.

2. The method of claim 1, wherein:
the rotor speed signal is acquired after the servo motor enters a steady state; and
determining an amplitude of a first-order component of the rotor speed signal comprises:
converting the rotor speed signal into a frequency domain signal based on Fourier transform,
determining a first-order component of the frequency domain signal, and
determining an amplitude of the first-order component.

3. The method of claim 1, wherein determining the amplitude of a first-order component of the rotor speed signal comprises:
performing order analysis on the rotor speed signal to determine a first-order component of the rotor speed signal; and
determining an amplitude of the first-order component.

4. The method of claim 1, wherein determining dynamic balance quality of the servo motor based on a comparison result comprises at least one of the following:
determining that the dynamic balance quality is qualified when the amplitude is less than or equal to the standard amplitude; and
determining that the dynamic balance quality is unqualified when the amplitude is greater than the standard amplitude.

5. The method of claim 1, wherein:
the number of set speeds is N, the number of amplitudes is N, and N is a positive integer of at least 2; and
determining dynamic balance quality of the servo motor based on a comparison result comprises at least one of the following:
determining that the dynamic balance quality is qualified when N amplitudes are less than or equal to respective N standard amplitudes; and
determining that the dynamic balance quality is unqualified when at least one amplitude is greater than respective at least one standard amplitude.

6. The method of claim 1, further comprising:
determining the standard rotor based on a dynamic balancing equipment;
installing the standard rotor in the standard servo motor of the same type as the servo motor;
obtaining respective rotor speed signals of the standard servo motor at respective set speeds;
determining respective amplitudes of respective first order components of the respective rotor speed signals; and
calibrating a relationship curve between set speed and standard amplitude based on the set speeds and respective amplitudes.

7. An apparatus for determining dynamic balance quality of servo motor, the apparatus comprising:
an obtaining module to obtain a rotor speed signal of a servo motor at a set speed;
a first determining module to determine an amplitude of a first-order component of the rotor speed signal;
a comparing module to compare the amplitude with a standard amplitude corresponding to the set speed, wherein the standard amplitude is determined based on a calibration process of a standard servo motor of the same type as the servo motor, and the standard servo motor comprises a standard rotor; and
a second determining module to determine dynamic balance quality of the servo motor based on a comparison result.

8. The apparatus of claim 7, wherein:
the rotor speed signal is acquired after the servo motor enters a steady state; and
the first determining module is configured to convert the rotor speed signal into a frequency domain signal based on Fourier transform, determine a first-order component of the frequency domain signal, and determine an amplitude of the first-order component.

9. The apparatus of claim 7, wherein the first determining module is configured to:
perform order analysis on the rotor speed signal to determine a first-order component of the rotor speed signal; and
determine an amplitude of the first-order component.

10. The apparatus of claim 7, wherein the second determining module is configured to perform at least one of the following:
determining that the dynamic balance quality is qualified when the amplitude is less than or equal to the standard amplitude; and
determining that the dynamic balance quality is unqualified when the amplitude is greater than the standard amplitude.

11. The apparatus of claim 7, wherein:
the number of set speeds is N, the number of amplitudes is N, and N is a positive integer of at least 2; and
the second determining module is configured to perform at least one of the following:
determining that the dynamic balance quality is qualified when N amplitudes are less than or equal to respective N standard amplitudes, and
determining that the dynamic balance quality is unqualified when at least one amplitude is greater than respective at least one standard amplitude.

12. The apparatus of claim 7, further comprising
a calibrating module to:
determine the standard rotor based on a dynamic balancing equipment;
install the standard rotor in the standard servo motor of the same type as the servo motor;
obtain respective rotor speed signals of the standard servo motor at respective set speeds;
determine respective amplitudes of respective first order components of the respective rotor speed signals; and
to calibrate a relationship curve between set speed and standard amplitude based on the set speeds and respective amplitudes.

13-15. (canceled)
